(19) United States
(12) Patent Application Publication
(10) Pub. No.: US 2012/0266163 A1
(43) Pub. Date: Oct. 18, 2012

(54) Virtual Machine Migration

(75) Inventors: Pamela C. Durham, Apex, NC (US); Bruce A. Smith, Austin, TX (US); Edward S. Suffern, Chapel Hill, NC (US)

(73) Assignee: INTERNATIONAL BUSINESS MACHINES CORPORATION, Armonk, NY (US)

(21) Appl. No.: 13/085,529

(22) Filed: Apr. 13, 2011

(51) Int. Cl. G06F 9/455

(52) U.S. Cl. 718/1

(57) ABSTRACT

Virtual machine migration, including: monitoring, by a management agent, the utilization of a system resource in a computing system; determining, by the management agent, a rate of change in the utilization of the system resource over a predetermined period of time; comparing, by the management agent, the rate of change in the utilization of the system resource over a predetermined period of time to a predetermined maximum allowable rate of change in the utilization of the system resource over the predetermined period of time; and taking, by the management agent, corrective action upon determining that the rate of change in the utilization of the system resource over the predetermined period of time exceeds the predetermined maximum allowable rate of change in the utilization of the system resource over the predetermined period of time.

### BACKGROUND OF THE INVENTION

1. Field of the Invention

The field of the invention is data processing, or, more specifically, methods, apparatus, and products for virtual machine migration.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Modern computing systems often include virtual machines (‘VMs’) that execute on actual physical devices. In systems with multiple VMs, a variety of resources are provided by the physical device that supports the VMs. These resources are required by and consumed by the VMs. For example, VMs consume network bandwidth, storage interface bandwidth, processor cycles, memory capacity, and so on. As the VMs are activated and applications are started, the resource utilization will begin to climb. This could result in poor performance due to unbalanced workload distribution where VMs on a particular device are over-utilizing the device's resources. In these situations, VMs may be moved to another device. However, current approaches typically wait for a resource over allocation condition to occur and then take action to rebalance the workloads—leading to delays and sub-optimal performance. In order to accommodate the likelihood of stalling a resource, the workload balancing thresholds are set extremely low, thereby not making as good a use of physical resources as possible.

### SUMMARY OF THE INVENTION

Methods, apparatus, and products for virtual machine migration, including: monitoring, by a management agent, the utilization of a system resource in a computing system; determining, by the management agent, a rate of change in the utilization of the system resource over a predetermined period of time; comparing, by the management agent, the rate of change in the utilization of the system resource over a predetermined period of time to a predetermined maximum allowable rate of change in the utilization of the system resource over the predetermined period of time; and taking, by the management agent, corrective action upon determining that the rate of change in the utilization of the system resource over the predetermined period of time exceeds the predetermined maximum allowable rate of change in the utilization of the system resource over the predetermined period of time.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example computer useful in virtual machine migration according to embodiments of the present invention.

FIG. 2 sets forth a flow chart illustrating an example method for virtual machine migration according to embodiments of the present invention.

FIG. 3 sets forth a flow chart illustrating an example method for virtual machine migration according to embodiments of the present invention.

### DETAILED DESCRIPTION OF EXAMPLE EMBODIMENTS

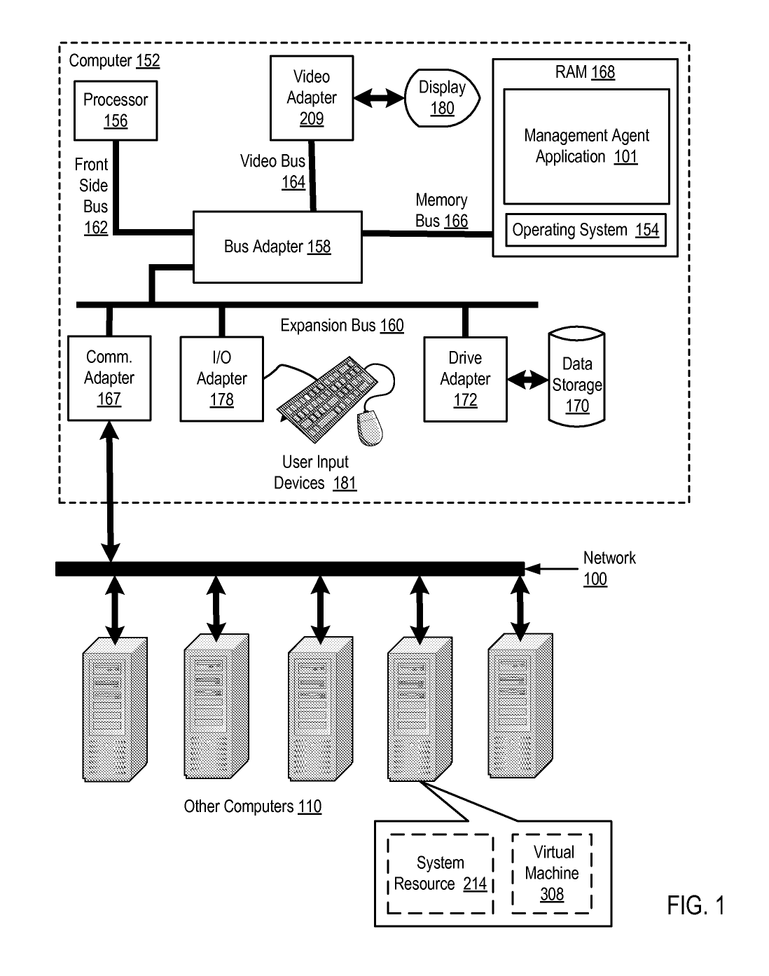

Example methods, apparatus, and products for virtual machine migration in accordance with the present invention are described with reference to the accompanying drawings, beginning with FIG. 1. Virtual machine migration in accordance with the present invention is generally implemented with computers, that is, with automated computing machinery. FIG. 1 therefore sets forth a block diagram of automated computing machinery comprising an example computer (152) useful in virtual machine migration according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a management agent application (101), a module of computer program instructions improved for virtual machine migration according to embodiments of the present invention. Also stored in RAM (168) is an operating system (154). Operating systems useful for virtual machine migration according to embodiments of the present invention include UNIX™, Linux™, Microsoft XP™, AIX™, IBM's i5/OS™, and others as will occur to those of skill in the art. The operating system (154) and management agent application (101) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for virtual machine migration according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example computer (152) of FIG. 1 includes a communications adapter (167) for data communications with other computers (110) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for virtual machine migration according to embodiments of the present invention include modems for wired dial-up communications, Ethernet (IEEE 802.3) adapters for wired data communications network communications, and 802.11 adapters for wireless data communications network communications.

In the example of FIG. 1, the other computers (110) may each include a system resource (214). Examples of a system resource (214) include, for example, a computer processor, computer memory, data communications bandwidth, and so on. In the example of FIG. 1, the other computers (110) may also include a virtual machine (308) that is executing on one of the other computers (110). A virtual machine (‘VM’) as the term is used in this specification refers to a software implementation of a machine, such as a computer. A virtual machine enables sharing of the underlying physical machine resources between different virtual machines, each of which may run its own operating system. The software layer providing the virtualization is called a virtual machine monitor or hypervisor. A hypervisor is a module of automated computing machinery that performs software and hardware platform-virtualization in order to enable multiple operating systems to run on a host computer concurrently in separate virtual machines. A hypervisor runs directly on the host's hardware to control hardware access and to monitor guest operating-systems.

In the example of FIG. 1, the computer (152) carries out virtual machine migration by monitoring, by the management agent application (101), the utilization of a system resource (214) in a computing system and determining, by the management agent application (101), a rate of change in the utilization of the system resource (214) over a predetermined period of time. In the process of carrying out virtual machine migration, the computer (152) also compares the rate of change in the utilization of the system resource (214) over a predetermined period of time to a predetermined maximum allowable rate of change in the utilization of the system resource (214) over the predetermined period of time. In the process of carrying out virtual machine migration, the computer (152) also takes, by the management agent application (101), corrective action upon determining that the rate of change in the utilization of the system resource (214) over the predetermined period of time exceeds the predetermined maximum allowable rate of change in the utilization of the system resource (214) over the predetermined period of time, for example, by migrating the virtual machine (308) to one of the other computers (110).

‘Migration,’ as the term is used in this specification, is the effective movement of a virtual machine (308) from one physical machine to another physical machine. Migration is descried here in terms of an ‘effective’ move of a VM from one physical machine to another, because migration refers not to the means of movement, but to the end result of the movement. That is, migration describes two states, one state in which a particular VM is executing on a particular physical machine, and a second state in which the particular VM is no longer executing on the particular physical machine but is instead executing on another physical machine. From the first state to the second state, therefore, one may describe the particular VM as having been moved from the particular physical machine to the other physical machine. The means by which such a ‘movement’ of a VM is carried out, however, may vary greatly within the scope of the present invention. Migrating a VM from a particular physical machine to another physical machine may include, for example, copying data representing the VM executing on the particular physical machine from the particular physical machine's memory to memory of another physical machine, uploading to and executing on another physical machine, a previously established image of the VM executing on the particular physical machine and halting execution of the VM executing on the particular physical machine, establishing a default image of a virtual machine in another physical machine and executing in the default image of the VM of instances of the same user-level applications executing in the VM of the particular physical machine, and so on.

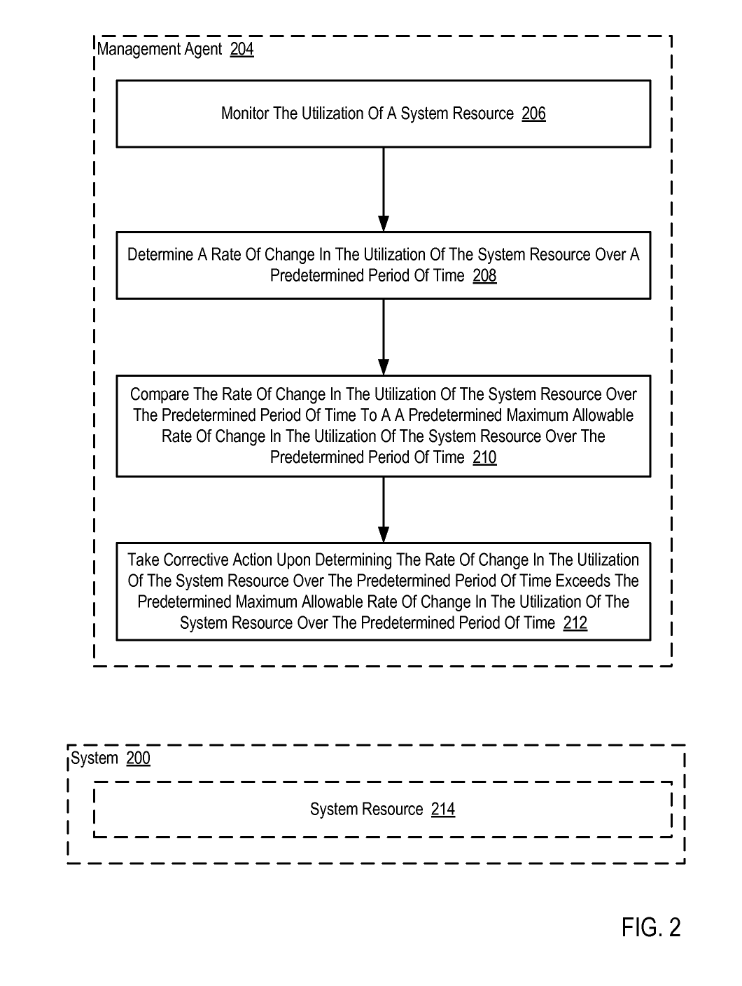

For further explanation, FIG. 2 sets forth a flow chart illustrating an example method for virtual machine migration according to embodiments of the present invention that includes monitoring (206), by a management agent (204), the utilization of a system resource (214). In the example of FIG. 2, the management agent (204) may be embodied as a module of automated computing machinery for monitoring the extent to which system resources within a particular system (200) are being utilized. In the example of FIG. 2, the management agent (204) may monitor (206) the utilization of a system resource (214), for example, by periodically requesting utilization data from the system (200) that includes the system resource (214). Utilization data may take many forms in dependence upon the natures of the system resource (214) that is being monitored (206). For example, if the system resource (214) that is being monitored (206) is a computer processor, the utilization data may include the number of processor cycles that were utilized over a period of time, the percentage of available processor cycles that were utilized over a period of time, and so on. Alternatively, if the system resource (214) that is being monitored (206) is computer memory, the utilization data may include the number of memory accessed that occurred over a period of time, the amount of memory that is currently available, the percentage of available memory that is currently available, and so on.

In the example of FIG. 2, monitoring (206) the utilization of a system resource (214) may be carried out, for example, by retaining a historical record of system resource (214) usage. The historical record of system resource (214) usage may be recorded, for example, in a resource utilization table as follows:

TABLE 1
Resource Utilization Table

| Resource | System | | |
|---|---|---|---|
| ID | ID | Utilization Rate | Time Period |
| CPU1 | Blade 1 | 5% | 1 |
| CPU2 | Blade 2 | 8% | 1 |
| CPU1 | Blade 1 | 11% | 2 |
| CPU2 | Blade 2 | 8% | 2 |
| CPU1 | Blade 1 | 16% | 3 |
| CPU2 | Blade 2 | 8% | 3 |
| CPU1 | Blade 1 | 24% | 4 |
| CPU2 | Blade 2 | 8% | 4 |
| CPU1 | Blade 1 | 33% | 5 |
| CPU2 | Blade 2 | 8% | 5 |

In the Resource Utilization Table above, the table is used to track the extent to which two system resources, in this case a CPU identified as CPU1 and a CPU identified as CPU2. The Resource Utilization Table above tracks the extent to which the system resources are utilized over multiple periods of time that are identified as time periods 1, 2, 3, 4, and 5. Each period of time may be 1 microsecond, 1 second, 1 minute, or any other unit of time as will occur to those of skill in the art. The Resource Utilization Table above also tracks the extent to the system resource is being utilized as a percentage of total resource capacity. For example, in time period 1, 5% of all available processing cycles for CPU1 were utilized.

The example of FIG. 2 also includes determining (208), by the management agent (204), a rate of change in the utilization of the system resource (214) over a predetermined period of time. In the example of FIG. 2, determining (208) a rate of change in the utilization of the system resource (214) over a predetermined period of time may be carried out by determining the extent to which utilization of the system resource (214) is increasing or decreasing over time. Such a determination can be made, for example, through the use of historical data representing system resource (214) utilization.

For example, using the historical data contained in the Resource Utilization Table described above, the rate of change in the utilization of CPU1 can be determined (208). In the Resource Utilization Table described above, the usage of CPU1 was 5% in time period 1, 11% in time period 2, 16% in time period 3, 24% in time period 4, and 33% in time period 5. In such an example, the rate of change in the utilization of CPU1 over a predetermined time period, such as from time period 1 to time period 5, is 660% (33% usage of all CPU1 cycles in time period 5 divided by 5% of all CPU1 cycles in time period 5). That is, the number of CPU cycles provided by CPU1 that were utilized in time period 5 was 6.6 times greater that than the number of CPU cycles provided by CPU1 that were utilized in time period 1. By contrast, over the same period of time there was no rate of change in the usage of CPU2, as 8% of the cycles provided by CPU2 were utilized in each of the time periods.

The example of FIG. 2 also includes comparing (210), by the management agent (204), the rate of change in the utilization of the system resource (214) over a predetermined period of time to a predetermined maximum allowable rate of change in the utilization of the system resource (214) over the predetermined period of time. In the example of FIG. 2, the predetermined maximum allowable rate of change in the utilization of the system resource (214) over the predetermined period of time represents the maximum rate of change in system resource (214) utilization that can be permitted without taking action to address the increase or decrease in system resource (214) utilization.

For example, consider a situation in which the predetermined maximum allowable rate of change in the utilization of a computer processor was 50%. In such an example, the rate of change in the utilization of CPU1 has exceeded the predetermined maximum allowable rate of change, while the rate of change in the utilization of CPU2 has not exceeded the predetermined maximum allowable rate of change. In such an example, the rapidly increasing utilization of CPU1 may need to be addressed otherwise CPU1 will be over-utilized if the rate of change in its utilization continues. In the example of FIG. 2, when the rate of change in the utilization of a particular system resource (214) exceeds the predetermined maximum allowable rate of change in the utilization of the system resource (214) over the predetermined period of time, the system resource (214) is at risk of being overburdened to the point that the performance of the system (200) itself can degrade below acceptable levels.

The example of FIG. 2 also includes taking (212), by the management agent (204), corrective action upon determining that the rate of change in the utilization of the system resource over the predetermined period of time exceeds the predetermined maximum allowable rate of change in the utilization of the system resource over the predetermined period of time. In the example of FIG. 2, taking (212) corrective action may be carried out, for example, by migrating virtual machines that are executing on the system (200) to a different system. As discussed above with reference to FIG. 1, virtual machines consume system resources (214). Migrating virtual machines that are executing on the system (200) to a different system can therefore help reduce the consumption of a particular system resource (214) on a particular system (200) when it has been determined that the rate of change in utilization of the system resource (214) has exceeded the predetermined maximum allowable rate of change in utilization of the system resource (214).

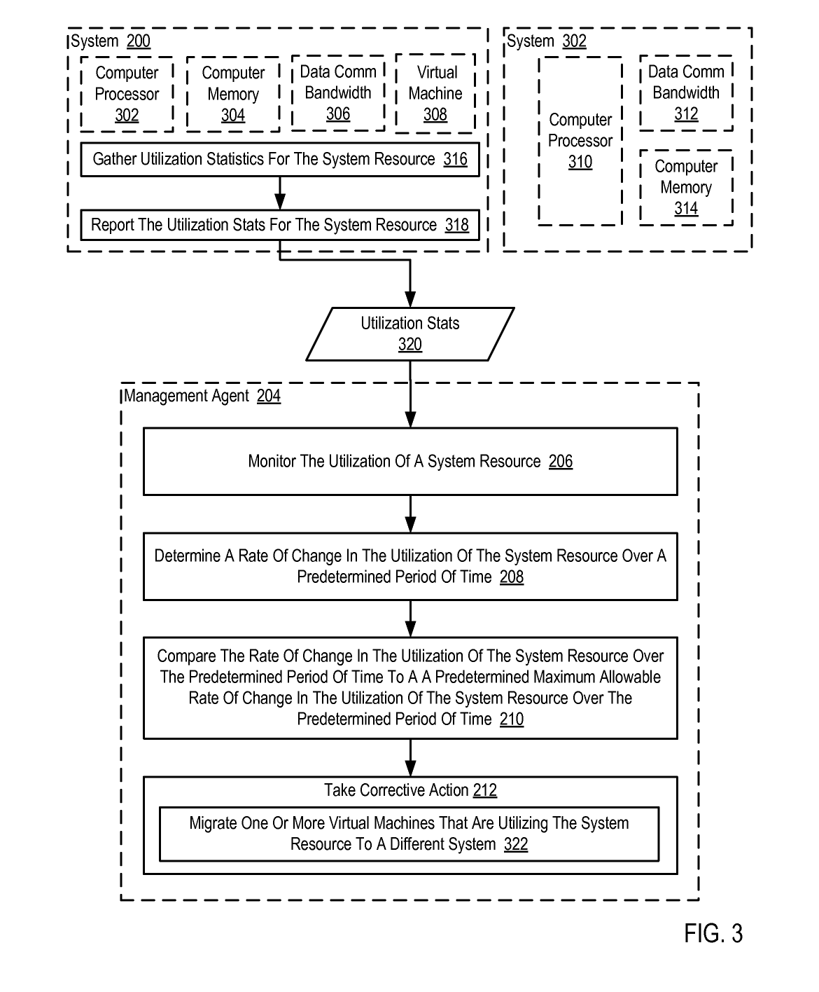

For further explanation, FIG. 3 sets forth a flow chart illustrating a further example method for virtual machine migration according to embodiments of the present invention. The example of FIG. 3 is similar to the example of FIG. 2, as it also includes monitoring (206), by a management agent (204), the utilization of a system resource in a computing system (200); determining (208), by the management agent (204), a rate of change in the utilization of the system resource over a predetermined period of time; comparing (210), by the management agent (204), the rate of change in the utilization of the system resource over a predetermined period of time to a predetermined maximum allowable rate of change in the utilization of the system resource over the predetermined period of time; and taking (212), by the management agent (204), corrective action upon determining that the rate of change in the utilization of the system resource over the predetermined period of time exceeds the predetermined maximum allowable rate of change in the utilization of the system resource over the predetermined period of time.

The example of FIG. 3 also includes gathering (316), by the computing system (200), utilization statistics for the system resource. In the example of FIG. 3, the system resource may be embodied as a computer processor (302), as computer memory (304), as data communications bandwidth (306) available to the computing system (200), and so on. Gathering (316) utilization statistics for the system resource may therefore be carried out by determining the number of CPU cycles used by the computer processor (302), determining the amount of computer memory (304) that is in use, determining the amount of data communications bandwidth (306) that is being used, and so on.

The example of FIG. 3 also includes reporting (318) to the management agent (204), by the computing system (200), the utilization statistics (320) for the system resource. In the example of FIG. 3, the utilization statistics (320) for the system resource may be reported (318) to the management agent (204), for example, by sending the utilization statistics (320) to the management agent (204) over a data communications link that couples the management agent (204) and the computing system (200) for data communications.

In the example of FIG. 3, taking (212), by the management agent (204), corrective action upon determining that the rate of change in the utilization of the system resource over the predetermined period of time exceeds the predetermined maximum allowable rate of change in the utilization of the system resource over the predetermined period of time includes migrating (322) one or more virtual machines (308) that are utilizing the system resource to a different system (302). In the example of FIG. 3, the one or more virtual machines (308) may be migrated to another system (302) that includes similar system resources as the system (200) that the one or more virtual machines (308) presently reside on. For example, the one or more virtual machines (308) can be migrated (322) to another system (302) that also includes a computer processor (310), computer memory (314), and data communications bandwidth (312) across a data communications network via a communications adapter as described above with reference to FIG. 1.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of virtual machine migration, the method comprising:
monitoring, by a management agent, the utilization of a system resource in a computing system;
determining, by the management agent, a rate of change in the utilization of the system resource over a predetermined period of time;
comparing, by the management agent, the rate of change in the utilization of the system resource over a predetermined period of time to a predetermined maximum allowable rate of change in the utilization of the system resource over the predetermined period of time; and
taking, by the management agent, corrective action upon determining that the rate of change in the utilization of the system resource over the predetermined period of time exceeds the predetermined maximum allowable rate of change in the utilization of the system resource over the predetermined period of time.

2. The method of claim 1 wherein taking, by the management agent, corrective action upon determining that the rate of change in the utilization of the system resource over the predetermined period of time exceeds the predetermined maximum allowable rate of change in the utilization of the system resource over the predetermined period of time includes migrating one or more virtual machines that are utilizing the system resource to a different system.

3. The method of claim 1 wherein the system resource is a computer processor.

4. The method of claim 1 wherein the system resource is computer memory.

5. The method of claim 1 wherein the system resource is data communications bandwidth.

6. The method of claim 1 further comprising:
gathering, by the computing system, utilization statistics for the system resource; and
reporting to the management agent, by the computing system, the utilization statistics for the system resource.

7. Apparatus for virtual machine migration, the apparatus comprising a computer processor, a computer memory operatively coupled to the computer processor, the computer memory having disposed within it computer program instructions that, when executed by the computer processor, carry out the steps of:
monitoring the utilization of a system resource in a computing system;
determining a rate of change in the utilization of the system resource over a predetermined period of time;
comparing the rate of change in the utilization of the system resource over a predetermined period of time to a predetermined maximum allowable rate of change in the utilization of the system resource over the predetermined period of time; and
taking corrective action upon determining that the rate of change in the utilization of the system resource over the predetermined period of time exceeds the predetermined maximum allowable rate of change in the utilization of the system resource over the predetermined period of time.

8. The apparatus of claim 7 wherein taking corrective action upon determining that the rate of change in the utilization of the system resource over the predetermined period of time exceeds the predetermined maximum allowable rate of change in the utilization of the system resource over the predetermined period of time includes migrating one or more virtual machines that are utilizing the system resource to a different system.

9. The apparatus of claim 7 wherein the system resource is a computer processor.

10. The apparatus of claim 7 wherein the system resource is computer memory.

11. The apparatus of claim 7 wherein the system resource is data communications bandwidth.

12. The apparatus of claim 7 further comprising computer program instructions that, when executed by the computer processor, carry out the steps of:
gathering utilization statistics for the system resource; and
reporting the utilization statistics for the system resource.

13. A computer program product for virtual machine migration, the computer program product disposed upon a computer readable storage medium, the computer program product comprising computer program instructions that, when executed, cause a computer to carry out the steps of:
monitoring the utilization of a system resource in a computing system;
determining a rate of change in the utilization of the system resource over a predetermined period of time;
comparing the rate of change in the utilization of the system resource over a predetermined period of time to a predetermined maximum allowable rate of change in the utilization of the system resource over the predetermined period of time; and
taking corrective action upon determining that the rate of change in the utilization of the system resource over the predetermined period of time exceeds the predetermined maximum allowable rate of change in the utilization of the system resource over the predetermined period of time.

14. The computer program product of claim 13 wherein taking corrective action upon determining that the rate of change in the utilization of the system resource over the predetermined period of time exceeds the predetermined maximum allowable rate of change in the utilization of the system resource over the predetermined period of time includes migrating one or more virtual machines that are utilizing the system resource to a different system.

15. The computer program product of claim 13 wherein the system resource is a computer processor.

16. The computer program product of claim 13 wherein the system resource is computer memory.

17. The computer program product of claim 13 wherein the system resource is data communications bandwidth.

18. The computer program product of claim 13 further comprising computer program instructions that, when executed, cause the computer to carry out the steps of:
gathering utilization statistics for the system resource; and
reporting the utilization statistics for the system resource.
